(19) United States
(12) Patent Application Publication
(10) Pub. No.: US 2026/0158438 A1
(43) Pub. Date: Jun. 11, 2026

(54) MEMBRANES, SYSTEMS, AND METHODS FOR ANESTHETIC GAS RECOVERY

(71) Applicant: Georgia Tech Research Corporation, Atlanta, GA (US)

(72) Inventors: Yuhe Cao, Atlanta, GA (US); William John Koros, Atlanta, GA (US); Zahra Shomali, Atlanta, GA (US)

(21) Appl. No.: 19/410,186

(22) Filed: Dec. 5, 2025

Related U.S. Application Data
(60) Provisional application No. 63/728,275, filed on Dec. 5, 2024.

(51) Int. Cl. B01D 53/22; B01D 67/00; B01D 69/08; B01D 69/12; B01D 71/02

(52) U.S. Cl. CPC B01D 53/228; B01D 67/0067; B01D 67/0088; B01D 69/087; B01D 69/12; B01D 71/021; B01D 2256/10; B01D 2256/14; B01D 2256/22; B01D 2257/11; B01D 2325/02831

(57) ABSTRACT

The various embodiments of the present disclosure relate generally to membranes, and more particularly to carbon molecular sieve membranes for the recovery of anesthetic gases. A membrane according to the disclosed technology includes a carbon molecular sieve (CMS) material configured to receive a gaseous feedstock and a plurality of pores defined by the CMS material, the plurality of pores configured to retain one or more recovered anesthetic products from the gaseous feedstock.

### CROSS-REFERENCE TO RELATED APPLICATIONS

This application claims the benefit, under 35 U.S.C. § 119(e), of U.S. Provisional Application No. 63/728,275, filed on 5 Dec. 2024, the entire contents and substance of which are incorporated herein by reference in their entirety as if fully set forth below.

### FIELD OF INVENTION

The various embodiments of the present disclosure relate generally to membranes, and more particularly to carbon molecular sieve membranes for the recovery of anesthetic gases.

### BACKGROUND

Xenon (Xe) is gaining application for anesthesia and therapeutic uses due to its unique properties that distinguish it from traditional anesthetics. The conventional, and most prevalent technique for recovering Xe from air, cryogenic distillation, requires high energy and capital expense. Xenon is produced only as a by-product of cryogenic air distillation due to its low atmospheric concentration of 0.087 ppmv. This production method is capital- and energy-intensive, resulting in high costs of $30,000-$60,000 per cubic meter (at standard conditions). Additionally, global xenon production is limited to 9-12 million liters annually, leading to a “supply ceiling.” If allocated exclusively for anesthesia, this supply would allow for only 800,000 treatments per year, with just 15 liters available per patient.

Recovery of Xe after usage is recognized as a promising way to reduce its cost as an anesthetic. Recovering xenon from exhaled anesthetic gases involves removing CO₂, N₂, and O₂. Currently, Xe recovery in medical institutions is done primarily through cryogenic condensation or adsorption methods. However, this approach requires managing logistics for the transfer and processing of xenon, adding complexity and cost to its recovery cycle.

Membrane separation avoids phase changes, unlike cryogenic distillation, which requires extreme temperatures. This significantly reduces the energy needed for the process. It allows for on-stream processing, enabling a more seamless, continuous recovery of Xe without the need to pause for phase transitions or re-cooling, increasing overall efficiency. Specialized membrane materials, such as small-pore zeolites (e.g., DD3R Zeolite, SAPO-34), are effective at selectively filtering out contaminants like CO₂ and N₂. This selectivity ensures higher Xe purity without additional separation steps. By eliminating the need for high-energy cryogenic equipment, membrane separation can reduce both operational and capital costs, making xenon recycling more economically viable.

Scalability is another factor in choosing the right membrane format; and zeolite membranes are not easy to scale up. CMS membranes had been investigated for Xe recovery, however, these membranes were fabricated by a posterior carbon chemical vapor deposition (CVD) and a high-temperature oxidation treatment combined process. An easier and simpler membrane process is needed to prepare the high-performance CMS for anesthetic agents' recovery. Accordingly, what is needed to address these challenges is a membrane separation approach that can remove CO₂ by a carbon molecular sieve membrane and possibly simultaneously remove nitrogen present in the anesthetic gas mixture to enable facile reuse.

### SUMMARY

According to an aspect of the present disclosure, a membrane is provided. The membrane can include a carbon molecular sieve (CMS) material configured to receive a gaseous feedstock. The membrane can include a plurality of pores defined by the CMS material, the plurality of pores configured to retain one or more recovered anesthetic products from the gaseous feedstock, the one or more recovered anesthetic products each having an atomic diameter of at least 3.8 Å.

In any of the embodiments disclosed herein, the one or more recovered anesthetic products each can have an atomic diameter of no less than 4.0 Å.

In any of the embodiments disclosed herein, the one or more recovered anesthetic products can include xenon.

In any of the embodiments disclosed herein, the gaseous feedstock can include at least one of oxygen, carbon dioxide, and nitrogen.

In any of the embodiments disclosed herein, at least one of the plurality of pores can be sized to permeate one or more permeated products of the gaseous feedstock, wherein the one or more permeated products can include at least one of oxygen, carbon dioxide, and nitrogen.

According to another aspect of the present disclosure, a method of anesthetic agent recovery is provided. The method can include feeding, to a membrane, a gaseous feedstock. The method can include producing a permeate stream from the membrane including one or more permeated products. The method can include obtaining a retentate stream from the membrane including one or more recovered anesthetic products, the one or more recovered anesthetic products having an atomic diameter of at least 3.8 Å.

In any of the embodiments disclosed herein, the one or more recovered anesthetic products each can have an atomic diameter of no less than 4.0 Å.

In any of the embodiments disclosed herein, the one or more recovered anesthetic products can include xenon.

In any of the embodiments disclosed herein, the gaseous feedstock can include at least one of oxygen, carbon dioxide, and nitrogen.

In any of the embodiments disclosed herein, the membrane can include a plurality of pores, at least one of the plurality of pores sized to permeate one or more permeated products of the gaseous feedstock, the one or more permeated products including at least one of oxygen, carbon dioxide, and nitrogen.

In any of the embodiments disclosed herein, the membrane can include a carbon molecular sieve (CMS) material.

In any of the embodiments disclosed herein, the method can further include reusing at least a portion of the retentate stream into an inhalant stream for anesthesia.

In any of the embodiments disclosed herein, the gaseous feedstock can include exhalant from a human body.

According to another aspect of the present disclosure, a method of manufacturing a carbon molecular sieve (CMS) membrane is provided. The method includes providing a fiber membrane. The method includes performing pyrolysis on the fiber membrane, a pyrolysis temperature ranging between 500 degrees Celsius and 1200 degrees Celsius. The method includes cooling the pyrolyzed fiber membrane to room temperature. The method includes constructing the CMS membrane from the cooled fiber membrane.

In any of the embodiments disclosed herein, the CMS membrane can include a plurality of pores configured to retain one or more recovered anesthetic products having an atomic diameter of at least 3.8 Å.

In any of the embodiments disclosed herein, the CMS membrane can include a plurality of pores configured to retain one or more recovered anesthetic products having an atomic diameter of at least 4.0 Å.

In any of the embodiments disclosed herein, the method can further include performing a dry-jet/wet-quench spinning process to fabricate the fiber membrane.

In any of the embodiments disclosed herein, the fiber membrane can include a dual-layer hollow fiber membrane.

In any of the embodiments disclosed herein, performing pyrolysis on the fiber membrane can include disposing the fiber membrane onto a wire mesh. Performing pyrolysis on the fiber membrane can include loading the fiber membrane into a quartz tube. Performing pyrolysis on the fiber membrane can include placing the quartz tube into a three-zone furnace.

In any of the embodiments disclosed herein, the method can further include dip-coating the fiber membrane with a polymer solution.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

Non-limiting and non-exhaustive examples are described with reference to the following figures.

FIG. 1 illustrates a system for gas separation, according to examples of the disclosed technology.

FIG. 2 is a flow diagram for a method for anesthetic agent recovery, according to examples of the disclosed technology.

FIG. 3 is a flow diagram for a method for manufacturing a carbon molecular sieve membrane, according to examples of the disclosed technology.

FIG. 4 illustrates a dual-layer fiber formation system having a sheath layer and porous core layer, according to examples of the disclosed technology.

FIG. 5 illustrates a dip-coating apparatus for preparing composite precursor hollow fiber membranes, according to examples of the disclosed technology.

FIG. 6 illustrates a continuous coating system for hollow fiber membranes, according to examples of the disclosed technology.

FIG. 7 illustrates a dry-jet/wet-quench spinning process system for fabricating asymmetric polymeric precursor hollow fiber membranes, according to examples of the disclosed technology.

FIG. 8 illustrates a pyrolysis system for preparing carbon molecular sieve membranes having a three-zone furnace, according to examples of the disclosed technology.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The present disclosure provides composition-of-matter and processes for recovering anesthetic agents. A carbon molecular sieve membrane separation process, which can remove carbon dioxide and nitrogen, meanwhile the effective anesthetic agents such as xenon, sevoflurane, isoflurane, desflurane, and nitrous oxide can be retained and reused. There are at least five contributions provided by the present disclosure: First, the disclosure provides a carbon molecular sieve (CMS) membrane having CO₂/Xenon permselectivity that is not achievable with pure polymer membranes. Besides the superior Xenon retention performance, this CMS membrane can also have high permselectivities for the following CO₂/anesthetic gas pairs (with shown anesthetic gas sieving diameters): CO₂/N₂O, CO₂/halothane (0.56 nm), CO₂/isoflurane (0.54 nm), CO₂/desflurane (0.53 nm), CO₂/sevoflurane (0.71 nm) separation performance. This contribution is referred to herein as an AAR (anesthetic agent recovery) membrane. Second, the present disclosure provides compositions-of-matter for AAR membranes containing precise molecular selective pores are able to reject the large anesthetic agents, and other entities to enable an AAR membrane in flat sheet, spiral wound or hollow fiber forms. Third, the present disclosure provides membranes in composite forms with an AAR thin (<5 mm) layer supported on a porous support in the forms identified in contribution 2 above. Fourth, the AAR membranes disclosed herein also can have Xenon/N₂ permeability ratios greater than unity to allow at least partial N₂ removal. Fifth, the AAR membranes disclosed herein can be generated from a single polymer formed membrane precursor or composite precursor membrane.

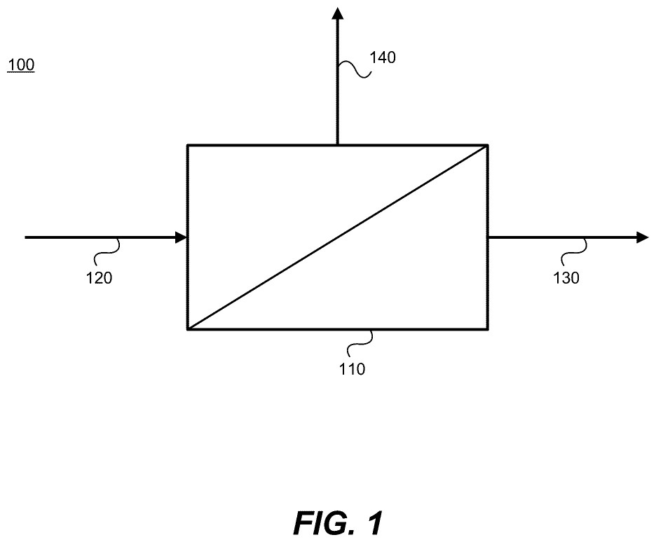

FIG. 1 illustrates a system 100 for gaseous filtration. As will be appreciated, the system 100 can be used for anesthetic gas recovery. As shown, the system 100 can include a membrane unit 110, a feed line 120, a permeate line 130, and a retentate line 140. The membrane unit 110 can contain any of the membranes described herein. In other words, the membrane unit 110 can include a membrane, including any example membrane discussed herein. The feed line 120 can be connected to the membrane unit 110 and can provide a feedstock to one side of the membrane. For example, the feedstock can be a gaseous feedstock. The retentate line 140 can be connected to the membrane unit 110 on the same side of the membrane as the feed line 120 and can receive a flow of components rejected by the membrane. The permeate line 130 can be connected to the membrane unit 110 on the opposite side of the membrane as the feed line 120 and can receive a flow of components permeating through the membrane.

The feed line 120, the permeate line 130, and the retentate line 140 can all be in fluid communication with the membrane unit 110. The lines can also contain various components to facilitate fluid flow through each respective line, such as valves, pumps, pipes, and the like. Such devices can be configured to meter the flow rate of any of the lines.

The membrane can include a variety of pore sizes due to the methods of forming or fabricating the membrane. For example, the membrane can have an arrangement of fibers and polymeric sheets, with pores defined therebetween. As can be appreciated, the arrangement of these fibers and sheets can define different groupings of pores based on size, as a distance between these features can be grouped based on an order of magnitude of the pore diameter. For example, the membrane can include macro-pores, micro-pores and ultramicro-pores. In this way, the fabrication of the membrane can be tailored to the atomic diameter of certain molecules within feedstock intended to be retained or permeated. Macro-pores and micro-pores provide non-selective passages for penetrants. In contrast, ultramicro-pores allow small molecules to pass while excluding larger ones (e.g., Xenon), also referred to as recovered products. As the membranes of the present disclosure can be directed to the recovery of anesthetic agents, in some cases, from an exhalant feed stream, the recovered products can be anesthetic agents, which can be referred to herein as recovered anesthetic products. For example, the anesthetic agent intended to be recovered can be xenon, in that the method of forming the membrane can be selected based on forming pores configured to retain/recover xenon and similarly sized particles. Similarly, at least one of the plurality of pores can be sized to permeate one or more permeated products of the gaseous feedstock. As discussed herein, the gaseous feedstock can include an exhalant from a human being. In this way, the one or more permeated products can include at least one of oxygen, carbon dioxide, and nitrogen. As can be appreciated, other agents, particles, molecules, or the like can be present in the gaseous feedstock. The permeated products can pass through the pores into the permeate line 130.

A diagonal line within the membrane unit 110 can represent the separation interface or selective layer that facilitates the separation of components from the feed streams into the permeate stream of the permeate line 130 and the retentate stream of the retentate line 140. The CMS material can provide molecular sieving properties that allow smaller molecules such as oxygen, carbon dioxide, and nitrogen to permeate through the pores while retaining larger anesthetic products such as xenon in the retentate stream.

In some embodiments, the membrane unit 110 can include a membrane having a carbon molecular sieve (CMS) material configured to receive a gaseous feedstock. The membrane can include a plurality of pores defined by the CMS material. The plurality of pores can be configured to retain one or more recovered anesthetic products from the gaseous feedstock. That is, the membrane of the membrane unit 110 can pass one or more permeated products through to the permeate line 130, and retain one or more recovered anesthetic products in the retentate line 140. The one or more recovered anesthetic products can each have an atomic diameter of at least 3.8 Å. In some cases, the one or more recovered anesthetic products can each have an atomic diameter of no less than 4.0 Å. For example, the one or more recovered anesthetic products can include xenon. In other cases, the membrane can be capable of recovering other anesthetic gases, such as sevoflurane, desflurane, and isoflurane. In other words, the one or more recovered products can have an atomic diameter between 4.7 and 5.6 Å. That is, in some cases, the one or more recovered anesthetic products can have an atomic diameter no less than 3.9 Å, 4.0 Å, 4.1 Å, 4.2 Å, 4.3 Å, 4.5 Å, 4.6 Å, 4.7 Å, 4.8 Å, 4.9 Å, 5.0 Å, 5.1 Å, 5.2 Å, 5.3 Å, 5.4 Å, 5.5 Å, 5.6 Å, or any atomic diameter value known for similar anesthetic gases by those skilled in the art. The gaseous feedstock can comprise at least one of oxygen, carbon dioxide, and nitrogen.

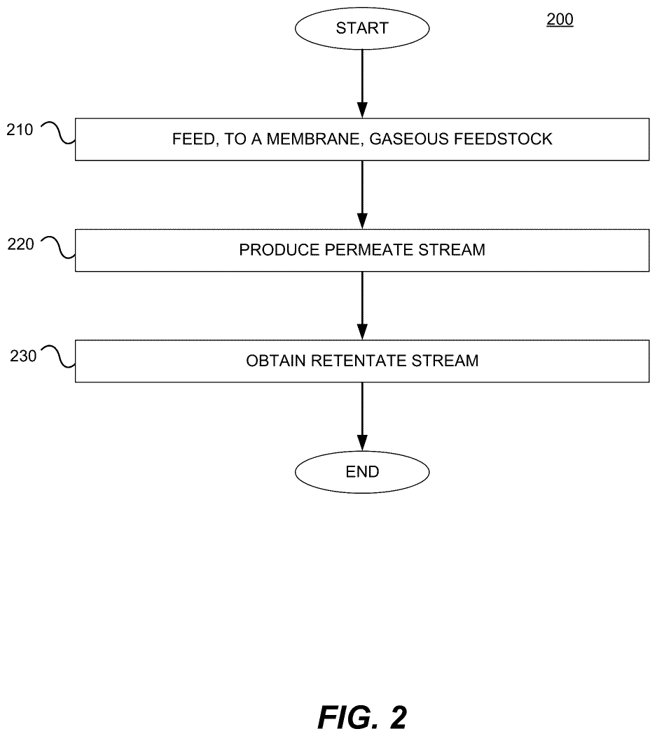

Referring to FIG. 2, a method 200 of anesthetic agent recovery can be implemented using the membrane separation principles described above. The method 200 can proceed through a sequential process for recovering anesthetic agents from a gaseous mixture.

The method 200 can include a step 210 where a gaseous feedstock is fed to a membrane. The gaseous feedstock can include exhalant from a human body. As can be appreciated, the gaseous feedstock can thus include some combination of oxygen, carbon dioxide, and nitrogen. The membrane used in the method 200 can include any examples of membranes discussed herein. The membrane used in the step 210 can include a carbon molecular sieve (CMS) material as described with reference to FIG. 1. The membrane can include a plurality of pores, with at least one of the plurality of pores sized to permeate one or more permeated products of the gaseous feedstock.

The method 200 can include a step 220 where a permeate stream is produced from the membrane. The permeate stream can include one or more permeated products that pass through the pores of the membrane. The one or more permeated products can include at least one of oxygen, carbon dioxide, and nitrogen, which have smaller molecular sizes that allow them to permeate through the CMS membrane structure.

The method 200 can include a step 230 where a retentate stream is obtained from the membrane. The retentate stream can include one or more recovered anesthetic products that are retained by the membrane due to their larger molecular size. The one or more recovered anesthetic products can have an atomic diameter of at least 3.8 Å. In some cases, the one or more recovered anesthetic products can each have an atomic diameter of no less than 4.0 Å. The one or more recovered anesthetic products can include xenon, which has a larger atomic diameter that prevents permeation through the molecular sieve pores.

The method 200 can further include reusing at least a portion of the retentate stream into an inhalant stream for anesthesia. This reuse capability can provide economic and environmental benefits by recovering valuable anesthetic agents that would otherwise be lost to waste gas systems.

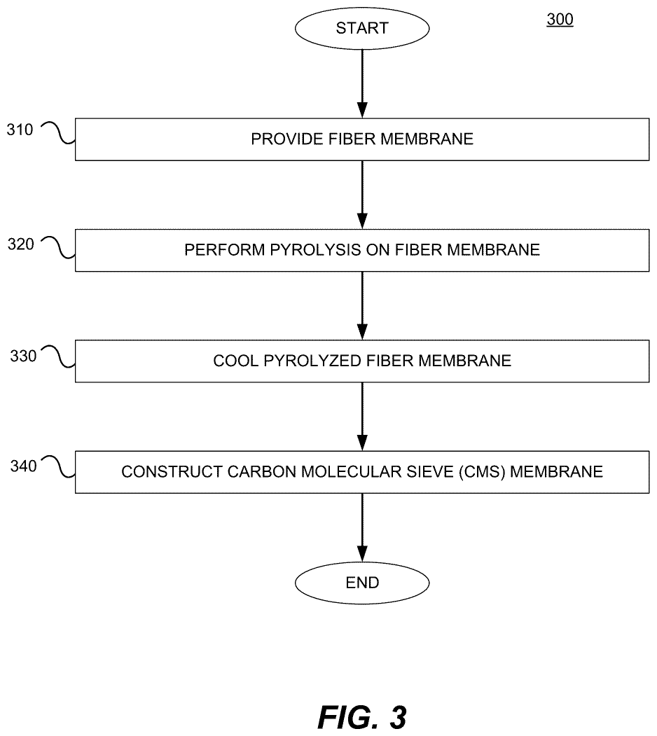

Referring to FIG. 3, a method 300 of manufacturing a carbon molecular sieve (CMS) membrane can be implemented to transform fiber membrane precursors into functional CMS membranes suitable for anesthetic agent recovery applications. The method 300 can proceed through a sequential manufacturing process that converts polymeric fiber membranes into carbon-based molecular sieving structures.

The method 300 can include a step 310 where a fiber membrane is provided. The fiber membrane can be fabricated by performing a dry-jet/wet-quench spinning process that creates the precursor structure for subsequent thermal treatment, as will be discussed in greater detail herein. The fiber membrane can include a dual-layer hollow fiber membrane having an asymmetric structure with different porosity characteristics across the membrane wall thickness. The fiber membrane can be dip-coated with a polymer solution to modify surface properties or add additional selective layers before pyrolysis treatment.

Following the step 310, the method 300 can move to a step 320 where pyrolysis is performed on the fiber membrane. The pyrolysis can be conducted at a pyrolysis temperature ranging between 500 degrees Celsius and 1200 degrees Celsius. Performing pyrolysis on the fiber membrane can include disposing the fiber membrane onto a wire mesh to provide support during thermal treatment. The process can further include loading the fiber membrane into a quartz tube and placing the quartz tube into a three-zone furnace that provides controlled heating zones for uniform temperature distribution. The pyrolysis step 320 can transform the polymeric structure of the fiber membrane into a carbon molecular sieve material through controlled thermal decomposition under inert atmosphere conditions.

The method 300 can include a step 330 where the pyrolyzed fiber membrane is cooled to room temperature. The cooling step 330 can be performed under controlled conditions to prevent oxidation of the newly formed carbon structure and to allow the molecular sieve pore structure to stabilize. The cooling process can be conducted gradually to minimize thermal stress and preserve the integrity of the carbon molecular sieve structure.

The method 300 can advance to a step 340 where the CMS membrane is constructed from the cooled fiber membrane. The construction step 340 can involve preparing the carbon molecular sieve material for use in gas separation applications. The CMS membrane from step 340 can include any membranes discussed herein. The CMS membrane formed through the step 340 can include a plurality of pores configured to retain one or more recovered anesthetic products having an atomic diameter of at least 3.8 Å. In some cases, the CMS membrane can include a plurality of pores configured to retain one or more recovered anesthetic products having an atomic diameter of at least 4.0 Å.

After completing the step 340, the method 300 can result in a functional CMS membrane suitable for anesthetic agent recovery applications. The method 300 can transform the original polymeric fiber membrane into a carbon-based molecular sieve that exhibits selective permeation properties based on molecular size differences, enabling effective separation of anesthetic agents from carrier gases.

### EXAMPLES

### Composite Hollow Fiber AAR Precursor Membrane Fabrication Via Dip-Coating

### Composite Precursor Hollow Fiber Membrane Formation

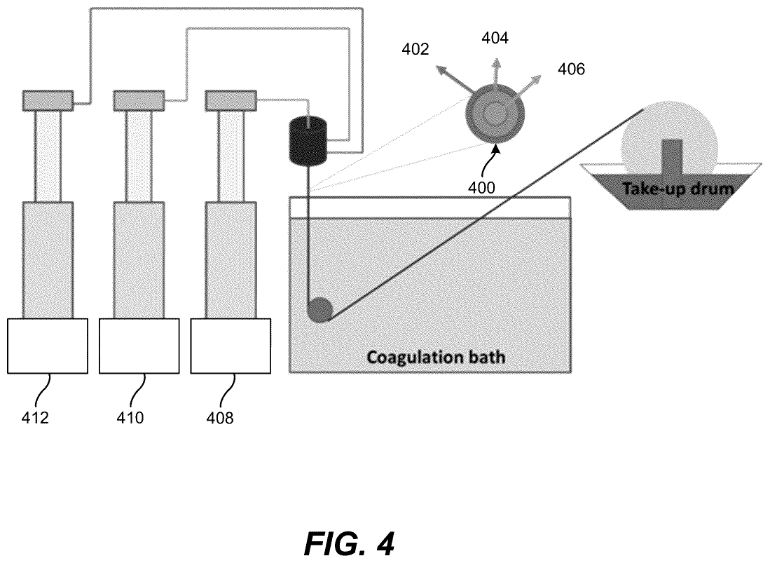

To illustrate an appealing example of the contributions described above, an asymmetric dual-layer hollow fiber membrane can be formed using a modified dry-jet/wet-quench spinning process like that reported in U.S. Patent Publication No. 2015/0011815A1 (which is incorporated herein by reference in its entirety), shown in FIG. 4. This dual-layer fiber 400 can comprise one sheath layer 402 of neat P84® and one porous core layer 404 with P84® and a hollow bore 406. A bore fluid 408 and two spinning dopes (core spinning dope 410 and sheath spinning dope 412), used to spin P84® dual-layer fiber membranes, enable precise tuning of the outer fiber surface porosity for facile coating. Such fibers are included herein by example.

### Dip-Coating for AAR Composite Precursor Hollow Fiber Membrane Preparation

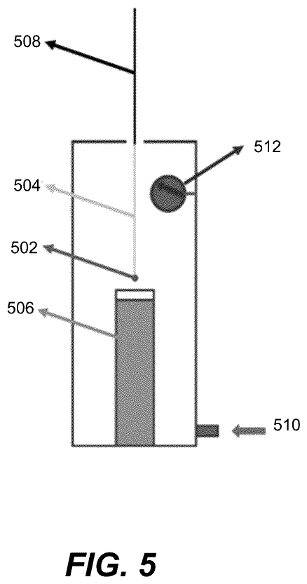

A dip-coating method can be applied to coat polymer solutions onto the outer surface of the P84® dual-layer fiber membranes, which follows a previously developed protocol in Y. Cao, K. Zhang, O. Sanyal, W. J. Koros, Carbon Molecular Sieve Membrane Preparation by Economical Coating and Pyrolysis of Porous Polymer Hollow Fibers, Angew Chem Int Ed Engl 58(35) (2019) 12149-12153. https://doi.org/10.1002/anie.201906653. As is shown in FIG. 5, one end of the fiber can be sealed by epoxy (in other words, an epoxy sealed end 502) to prevent the solution from entering the lumen side. Coating of polymer on the precursor hollow fiber membrane can be conducted by dipping the precursor fiber 504 in the polymer solution 506 for 30 s. The precursor fiber 504 can be taped onto a stainless-steel rod 508 to move the precursor fiber 504 in and out of the coating solution and evaporation zone. The dip-coated hollow fibers can be dried under vacuum at 75° C. for 2 h hours. The dip-coating can be conducted at high relative humidity (RH) of 60% (in atmosphere) or low RH of 10% (in a coating chamber purged by dry nitrogen 510, FIG. 5) as read by a humidity meter 512.

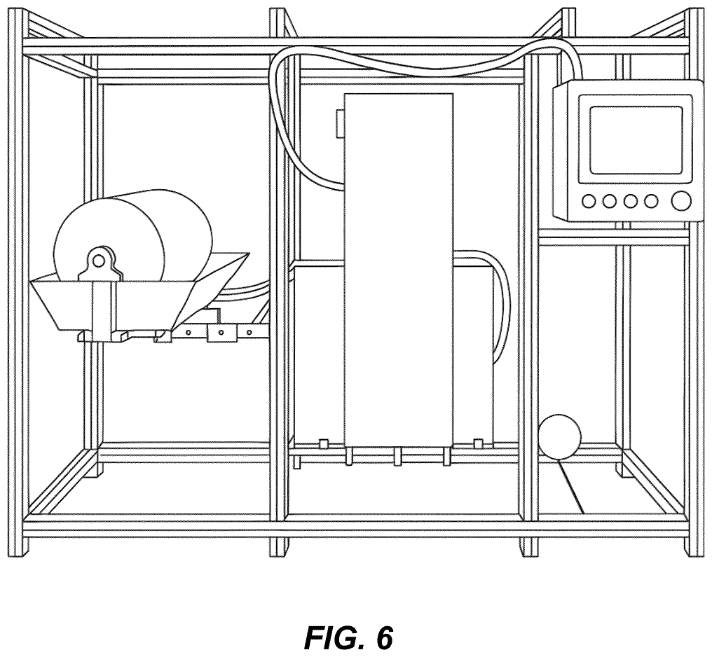

To expedite large module formation, a continuous coater (shown in FIG. 6) can also be used, based on the optimized lab-scale batch coating conditions.

### Sheath-Core Spun AAR Precursor Composite Hollow Fiber Membrane

In yet another example of an even more advanced aspect of the present disclosure, for one skilled in the art that with optimization of the spinning process in FIG. 4, it is also possible to simultaneously form the sheath-core AAR precursor membranes. Without being bound by details, this aspect of spinning an AAR sheath layer on a core support is also included within the present disclosure.

### Monolithic Spun AAR Precursor Hollow Fiber Membrane

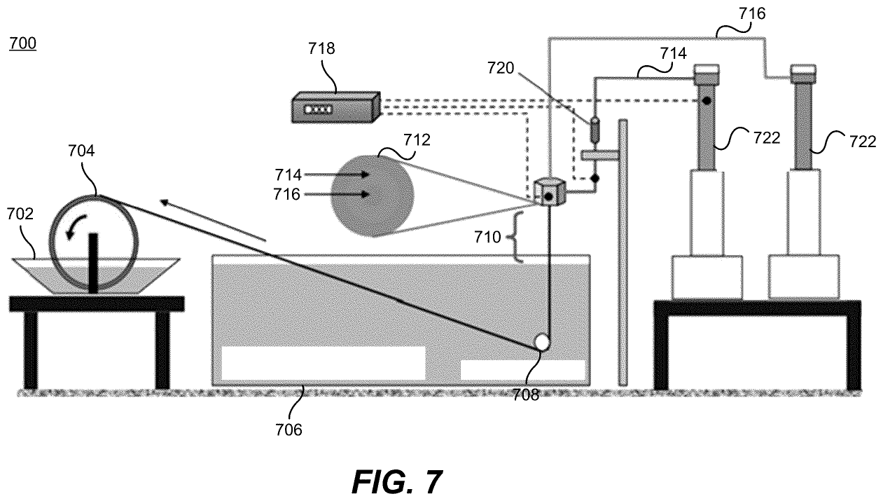

Besides the composite AAR precursor membrane fabrication, asymmetric polymeric AAR precursor hollow fiber membranes can be fabricated via a dry-jet/wet-quench spinning process, as illustrated in FIG. 7 using many viable precursor polymers, such as but not limited to polyimides. The dry-jet/wet-quench spinning process can be executed by a system 700 including, but not limited to, the following features and components: a rinse bath 702, a take-up drum 704, a quench bath 706, a guide roll 708, an air gap 710, a spinneret 712, dope 714, bore fluid 716, a temp controller 718, a filter 720, and solution delivery pump(s) 722.

### AAR CMS Membrane Preparation

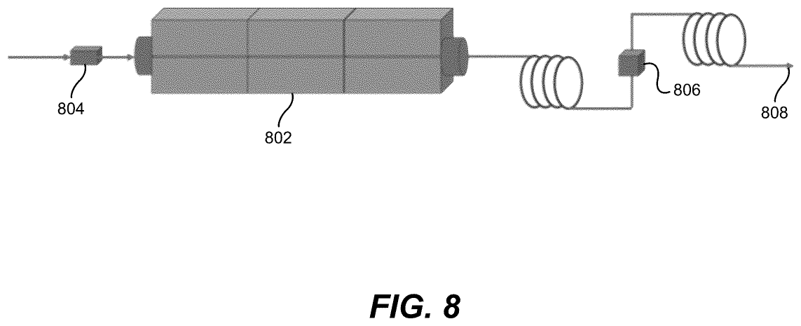

The three types of AAR precursor membrane mentioned above can undergo pyrolysis to prepare the AAR CMS membrane. An exemplary pyrolysis set-up is shown in FIG. 8. The fiber membranes can be placed on a stainless-steel wire mesh plate (McMaster Carr, Robbinsville, NJ) and loaded into in a quartz tube (National Scientific Company, GE Type 214 quartz tubing, Quakertown, PA, USA), which can be placed into a three-zone furnace 802 (Thermocraft, Inc., model #XST-3-0-24-3C, Winston-Salem, NC) connected with a multichannel temperature controller (Omega Engineering, Inc., Stamford, CT), a mass flow controller 804, and an O₂ sensor 806. A vent 808 can be positioned downstream the furnace 802 The entire system can be purged with ultra-high purity (UHP) argon for a minimum of 12 hours until O₂ level in the furnace 802 dropped below 1 ppm. The fiber membranes can be pyrolyzed with continuous purge of UHP argon (500 cc/min) using the temperature protocol given in Table 7 and Table 8. The final pyrolysis temperature ranges from 500° C. to 1200° C. can be used as the final temperature. The furnace 802 can be naturally cooled to room temperature after the heating protocol is completed. CMS hollow fiber membrane modules can be constructed as described in a previous work, D. Q. Vu, W. J. Koros, S. J. Miller, High Pressure CO2/CH4 Separation Using Carbon Molecular Sieve Hollow Fiber Membranes, Ind. Eng. Chem. Res. 41(3) (2002) 367-380. https://doi.org/10.1021/ie010119w. Not only Ar can be used in this process, but other atmospheres, such as N₂ or inert atmosphere with trace (ppm) amount of O₂ can be used.

Modeling and Simulation of the Membrane Efficiency with Different Operation Conditions

Herein, the ability of such an AAR CMS membrane is illustrated in an actual module for a countercurrent flow pattern. Other calculations of flow patterns such as crossflow modules can be considered, but the current example effectively shows the benefits of the membranes disclosed herein.

Based on the Matrimid CMS membrane at 900° C.:

$${P}_{CO2} = 25 Barrer and {α}_{CO2 / CH4} = 3650 , assuming the CMS membrane has ℓ = 1 μm thickness , then {P}_{CO2} / ℓ = 25 GPU and {P}_{CH4} / ℓ = 0.00685 GPU ; \qquad ( 1 )$$

$$Since {α}_{N2 / CH4} = 63 , {α}_{O2 / N2} = 21 , thus {P}_{N2} / ℓ = 0.43 GPU and {P}_{O2} / ℓ = 9.06 GPU . \qquad ( 2 )$$

For the Xenon membrane separation simulation, Xenon is considered to have a similar permeation performance to CH₄. Therefore, the feed gas composition and membrane performance are shown in Table 1. The membrane operation parameters are shown in Table 2, 0.6 m length fibers are used for the separation. As is shown in Table 3, 99.75% Xenon recovery rate can be achieved with the final retentate gas compositions as follows: 6.7% O₂, 89.2% Xenon, 0.2% CO₂ and 3.9% N₂. Since the retentate flow is 7.27 SCFH, to get 67% Xe recycled stream that can be reused as inhale stream, 2.41 SCFH needs to be added to the retentate flow. The composition of the final mixed stream can be: 29.9% 02, 67% Xenon, 0.15% CO₂ and 2.95% N₂, which meets the standards of inhale anesthetic gas composition. Without being constrained by this example, the above nonlimiting case illustrated the utilities of embodiments of the present disclosure.

TABLE 1
Feed gas composition and membrane permeance.

| ID# | Component | Mole fraction | Permeance (GPU) |
|---|---|---|---|
| 1 | Oxygen | 0.267 | 9.06 |
| 2 | Xenon | 0.65 | 0.00685 |
| 3 | Carbon Dioxide | 0.05 | 25 |
| 4 | Nitrogen | 0.033 | 0.43 |

TABLE 2
Parameters of membrane process.

| Parameters | Value | Units |
|---|---|---|
| Feed Flowrate | 10.0 | Standard cubic foot per hour (SCFH) |
| Temperature | 25.00 | ° C. |
| Feed Pressure | 14.70 | psia |
| Permeate Pressure | 0.60 | psia |
| Number of Fibers | 50000 | |
| Fiber OD | 300.0 | micron |
| Fiber ID | 150.0 | micron |
| Total membrane area | 28.3 | m² |
| Active Length | 0.6 | m |

| | |
|---|---|
| Gas feed location | Shell side |

TABLE 3
Simulation results with 0.6 m hollow fiber membrane active length.

| | Oxygen | Xenon | Carbon Dioxide | Nitrogen |
|---|---|---|---|---|
| Component (mol. | | | | |
| frac.) | | | | |
| Feed | 0.2670 | 0.6500 | 0.0500 | 0.0330 |
| Permeate | 0.8002 | 0.0059 | 0.1777 | 0.0162 |
| Retentate | 0.0665 | 0.8922 | 0.0020 | 0.0393 |

Recoveries (%)

| | | | | |
|---|---|---|---|---|
| (Retentate/Feed) | 81.90 | 0.25 | 97.09 | 13.45 |

| | |
|---|---|
| Stage cut | 27.3% |

### Carbon Molecular Sieve (CMS) Membranes for Recovery of an Advanced Inhalable Anesthetic Agent-Results

### Membrane Fabrication

To form polymeric dense films, dried polymer was dissolved in DMF at a concentration of 5% by mass. After complete dissolution, the solutions were transferred onto a Teflon dish at 50° C. and allowed for slow solvent evaporation. After approximately 24 h of solvent evaporation, the films were removed from the Teflon dish and dried under vacuum at 180° C. overnight. Polymeric films were approximately 110 μm thick, with densities of 1.24 g/cm³.

CMS dense films were fabricated via inert pyrolysis under ultra-high purity Argon. Discs approximately 1.5 cm in diameter were cut from polymer films using a round hole punch. These were placed onto a grooved quartz plate and loaded into a pyrolysis furnace. The furnace was purged with Ar until the O₂ concentration was beneath 2 ppm before starting a pyrolysis. Temperature profiles for the final pyrolysis temperature of 700° C. consisted of the following steps: Room temperature to 250° C. at 13.3° C./min; 250° C. to 685° C. at 3.85° C./min; 685° C. to 700° C. at 0.25° C./min; Soak at 700° C. for 120 min; Natural cooling

After natural cooling back to room temperature, pyrolyzed films were removed from the furnace and loaded into cells for permeation measurements. The CMS films were slightly Thinner than their polymeric precursors, with an average value of 94 μm, with densities of 1.49 g/cm³.

### Preparation of CMS Hollow Fiber Membranes

Asymmetric precursor hollow fiber membranes were fabricated by a dry-jet/wet-quench spinning process. Matrimid® polymer power was first dried in a vacuum oven at 120° C. overnight to remove moisture and residual organics. A spinning dope was then made in a Qorpak® glass bottle sealed with a Teflon® cap and dissolved by placing on a roller at room temperature. A typical dope consists of 26.2 wt % Matrimid®, 53 wt % 1-Methyl-2-pyrrolidinone (NMP, Sigma-Aldrich Inc., 99.5%), 14.9 wt % Ethanol (Sigma-Aldrich Inc., ≥99.5%), 5.9 wt % Tetrahydrofuran (THF, Sigma-Aldrich Inc., 99.5%). Once the dope was homogeneous, it was loaded into a 500-mL syringe pump (ISCO Inc., Lincoln, NE) and allowed to degas overnight. Bore fluid was loaded into a separate 100-mL syringe pump. The dope and bore fluid were then co-extruded through a spinneret. Both the dope and the bore fluid were filtered in-line between the delivery pumps and the spinneret. Temperature control was applied for the spinning process. Thermocouples were placed on the spinneret, the dope filter and the dope pump. After passing through an air gap, the nascent membrane was immersed into a water quench bath. The phase-separated fiber spin line was collected on a 0.32 m diameter rotating polyethylene cylinder after passing over Teflon® guides. Once cut from the take-up drum, the fibers were rinsed in at least four separate water baths over a course of 48 h. The fibers were then solvent exchanged in glass containers with three separate 20 min methanol (VWR International LLC., ACS grade) baths followed by 3 separate 20 min hexane (VWR International LLC., ACS grade) baths and dried under vacuum at 75° C. for 3 h. The pyrolysis process for hollow fiber was similar to that for dense film pyrolysis.

### Permeation Measurements

CMS hollow-fiber membranes were characterized with CO₂ and Xe single-gas permeation at 5, 25, and 50 psi feed pressure (vacuum downstream) in constant-volume variable-pressure permeation cells at 35° C.

### Results

### Pure Gas Separation Performance for Dense Film Membranes

Pure CO₂ and Xe gas transport properties at 50 psi in Matrimid-drived CMS dense film membranes pyrolyzed at 700° C.

| CMS700 | |
|---|---|
| P_{CO2} (Barrers) | 592.4 |
| P_{Xe} (Barrers) | 0.42 |
| α_{CO2/Xe} | 1410.47 |
| ${D}_{CO 2} ( \frac{{cm}^{2}}{s} )$ | 6.17 × 10⁻⁸ |
| ${D}_{Xe} ( \frac{{cm}^{2}}{s} )$ | 5.29 × 10⁻¹¹ |
| ${S}_{CO 2} ( \frac{cc ( STP )}{{cm}^{3} \cdot cm Hg} )$ | 0.96 |
| ${S}_{Xe} ( \frac{cc ( STP )}{{cm}^{3} \cdot cm Hg} )$ | 0.79 |

### Pure Gas Separation Performance for Dense-Walled Hollow Fibers

Pure CO₂ and Xe gas transport properties at 5, 25, and 50 psi in Matrimid-drived CMS dense film membranes pyrolyzed at 700° C.

CMS700

| | | | |
|---|---|---|---|
| Pressure (psi) | 5 | 25 | 50 |
| P_{CO2} (Barrers) | 686 | 625 | 587 |
| P_{Xe} (Barrers) | 0.67 | 0.52 | 10.40 |
| α_{CO2/Xe} | 1023 | 1200 | 1467.5 |
| ${D}_{CO 2} ( \frac{{cm}^{2}}{s} )$ | 2.44 × 10⁻⁸ | 4.44 × 10-8 | 5.71 × 10-8 |
| ${D}_{Xe} ( \frac{{cm}^{2}}{s} )$ | 1.46 × 10⁻¹¹ | 3.72 × 10-11 | 9.18 × 10-11 |
| ${S}_{CO 2} ( \frac{cc ( STP )}{{cm}^{3} \cdot cm Hg} )$ | 2.82 | 1.41 | 0.95 |
| ${S}_{Xe} ( \frac{cc ( STP )}{{cm}^{3} \cdot cm Hg} )$ | 2.87 | 1.40 | 0.73 |

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A membrane comprising:
a carbon molecular sieve (CMS) material configured to receive a gaseous feedstock; and
a plurality of pores defined by the CMS material, the plurality of pores configured to retain one or more recovered anesthetic products from the gaseous feedstock, the one or more recovered anesthetic products each having an atomic diameter of at least 3.8 Å.

2. The membrane of claim 1, wherein the one or more recovered anesthetic products each have an atomic diameter of no less than 4.0 Å.

3. The membrane of claim 1, wherein the one or more recovered anesthetic products comprise xenon.

4. The membrane of claim 1, wherein the gaseous feedstock comprises at least one of oxygen, carbon dioxide, and nitrogen.

5. The membrane of claim 1, wherein at least one of the plurality of pores is sized to permeate one or more permeated products of the gaseous feedstock, wherein the one or more permeated products comprise at least one of oxygen, carbon dioxide, and nitrogen.

6. A method of anesthetic agent recovery, comprising:
feeding, to a membrane, a gaseous feedstock;
producing a permeate stream from the membrane comprising one or more permeated products; and
obtaining a retentate stream from the membrane comprising one or more recovered anesthetic products, the one or more recovered anesthetic products having an atomic diameter of at least 3.8 Å.

7. The method of claim 6, wherein the one or more recovered anesthetic products each have an atomic diameter of no less than 4.0 Å.

8. The method of claim 6, wherein the one or more recovered anesthetic products comprise xenon.

9. The method of claim 6, wherein the gaseous feedstock comprises at least one of oxygen, carbon dioxide, and nitrogen.

10. The method of claim 6, wherein the membrane comprises a plurality of pores, at least one of the plurality of pores sized to permeate one or more permeated products of the gaseous feedstock, the one or more permeated products comprising at least one of oxygen, carbon dioxide, and nitrogen.

11. The method of claim 6, wherein the membrane comprises a carbon molecular sieve (CMS) material.

12. The method of claim 6, further comprising reusing at least a portion of the retentate stream into an inhalant stream for anesthesia.

13. The method of claim 6, wherein the gaseous feedstock comprises exhalant from a human body.

14. A method of manufacturing a carbon molecular sieve (CMS) membrane, comprising:
providing a fiber membrane;
performing pyrolysis on the fiber membrane, a pyrolysis temperature ranging between 500 degrees Celsius and 1200 degrees Celsius;
cooling the pyrolyzed fiber membrane to room temperature; and
constructing the CMS membrane from the cooled fiber membrane.

15. The method of claim 14, wherein the CMS membrane comprises a plurality of pores configured to retain one or more recovered anesthetic products having an atomic diameter of at least 3.8 Å.

16. The method of claim 14, wherein the CMS membrane comprises a plurality of pores configured to retain one or more recovered anesthetic products having an atomic diameter of at least 4.0 Å.

17. The method of claim 14, further comprising performing a dry-jet/wet-quench spinning process to fabricate the fiber membrane.

18. The method of claim 17, wherein the fiber membrane comprises a dual-layer hollow fiber membrane.

19. The method of claim 14, wherein performing pyrolysis on the fiber membrane comprises:
disposing the fiber membrane onto a wire mesh;
loading the fiber membrane into a quartz tube; and
placing the quartz tube into a three-zone furnace.

20. The method of claim 14, further comprising dip-coating the fiber membrane with a polymer solution.
